(19) United States
(12) Patent Application Publication
(10) Pub. No.: US 2020/0137155 A1
(43) Pub. Date: Apr. 30, 2020

(54) SYSTEM AND METHOD FOR PEER-TO-PEER COMMUNICATION IN PARTIAL MESH NETWORK

(71) Applicant: SAMSUNG SDS CO., LTD., Seoul (KR)

(72) Inventors: Ho-Sung Ahn, Seoul (KR); Ji-Won Jung, Seoul (KR); Jae-Gu Kim, Seoul (KR); Hee-Tae Yoon, Seoul (KR); Jun-Ho Kang, Seoul (KR); Sang-Bum Kim, Seoul (KR)

(21) Appl. No.: 16/663,730

(22) Filed: Oct. 25, 2019

(30) Foreign Application Priority Data
Oct. 26, 2018 (KR) 10-2018-0128991

(51) Int. Cl. H04L 29/08

(52) U.S. Cl. CPC H04L 67/1078; H04L 67/28; H04L 67/26

(57) ABSTRACT

A peer-to-peer communication system in a partial mesh network includes a relay server configured to add, to a relay list, subscription information of a reception terminal included in a data subscription request in response to the data subscription request received from the reception terminal and a transmission terminal configured to receive the data subscription request from the relay server and add the subscription information of the reception terminal to a server transmission list.

### CROSS REFERENCE TO RELATED APPLICATION

This application is based on and claims priority under 35 U.S.C. 119 to Korean Patent Application No. 10-2018-0128991, filed on Oct. 26, 2018, in the Korean Intellectual Property Office, the disclosures of which is herein incorporated by reference in their entireties.

### BACKGROUND

### 1. Field

Disclosed embodiments relate to a technology for efficient data transmission and reception between peers in a partial mesh network.

### 2. Discussion of the Related Art

A partial mesh network is a kind of peer-to-peer communication method, and means a network capable of selectively using a method through a relay server when data is transmitted between a transmission peer and a reception peer (i.e., server communication method) and a method through a direct connection between peers (i.e., direct communication method).

In the partial mesh network, a reception peer (or reception terminal) has an advantage in that it can selectively use an advantageous method of the server communication method and the direct communication method. If data transmission path information desired by the reception peer is not accurately synchronized for the transmission peer (or transmission terminal) side, however, a data redundancy transmission problem may occur. For example, it is assumed that a reception peer has changed its communication method to the direct communication method while subscribing data from a transmission peer using the server communication method. In this case, if such a change is not correctly transmitted to a relay server, there is a problem in that the same data is redundantly transmitted through the transmission peer and the relay server.

### SUMMARY

Disclosed embodiments provide technical means for preventing the redundant transmission of data and efficiently transmitting data in a partial mesh network.

In an embodiment, there is provided a peer-to-peer communication system, comprising a relay server configured to add, to a relay list, subscription information of a reception terminal included in a data subscription request in response to the data subscription request received from the reception terminal and a transmission terminal configured to receive the data subscription request from the relay server and add the subscription information of the reception terminal to a server transmission list.

The subscription information may comprise identification information of the reception terminal and data information to be received by the reception terminal.

When a data subscription cancellation request is received from the reception terminal, the relay server may be further configured to delete the subscription information of the reception terminal from the relay list.

The transmission terminal may be further configured to receive the data subscription cancellation request from the relay server, and delete the subscription information of the reception terminal from the server transmission list.

When the data subscription request is directly received from the reception terminal, the transmission terminal may be further configured to add the subscription information of the reception terminal to a peer transmission list.

When a data subscription cancellation request is directly received from the reception terminal, the transmission terminal may be further configured to delete the subscription information of the reception terminal from the peer transmission list.

If the number or ratio of terminals that have requested a subscription for identical data, among a plurality of reception terminals included in the peer transmission list, is a reference value or more, the transmission terminal may be further configured to transmit a subscription path change request to a corresponding terminal.

A reception terminal that has received the subscription path change request may be configured to transmit a subscription request to the relay server, and transmit a subscription cancellation request to the transmission terminal.

In another embodiment, there is provided a peer-to-peer communication method, comprising receiving, by a relay server, a data subscription request from a reception terminal, adding, by the relay server, subscription information of the reception terminal included in the received subscription request to a relay list, and receiving, by the transmission terminal, the data subscription request from the relay server and adding the subscription information of the reception terminal to a server transmission list.

The subscription information may comprise identification information of the reception terminal and data information to be received by the reception terminal. When a data subscription cancellation request is received from the reception terminal, the relay server may be further configured to delete the subscription information of the reception terminal from the relay list.

The transmission terminal may be further configured to receive the data subscription cancellation request from the relay server, and may delete the subscription information of the reception terminal from the server transmission list.

When the data subscription request is directly received from the reception terminal, the transmission terminal may be further configured to add the subscription information of the reception terminal to a peer transmission list.

When a data subscription cancellation request is directly received from the reception terminal, the transmission terminal may be further configured to delete the subscription information of the reception terminal from the peer transmission list.

If the number or ratio of terminals that have requested a subscription for identical data, among a plurality of reception terminals included in the peer transmission list, is a reference value or more, the transmission terminal may be further configured to transmit a subscription path change request to a corresponding terminal.

A reception terminal that has received the subscription path change request may be configured to transmit a subscription request to the relay server, and transmit a subscription cancellation request to the transmission terminal.

### BRIEF DESCRIPTION OF THE DRAWINGS

FIG. 1 is a block diagram of a peer-to-peer communication system in a partial mesh network according to an embodiment.

FIG. 2 is a flowchart for illustrating a process of subscribing, by a reception terminal, data from a transmission terminal using a server communication method in a peer-to-peer communication system according to an embodiment.

FIG. 3 is a flowchart for illustrating a process of subscribing, by a reception terminal, data from a transmission terminal using a direct communication method in a peer-to-peer communication system according to an embodiment.

FIG. 4 is an exemplary diagram illustrating an example in which a transmission terminal provides data to five reception terminals R1, R2, R3, R4 and R5.

FIG. 5 is a flowchart for illustrating a process of changing the data subscription method of a reception terminal from a direct communication method to a server communication method in a peer-to-peer communication system according to an embodiment.

FIGS. 6 and 7 are exemplary diagrams for illustrating a process of changing the data subscription method of a reception terminal from a direct communication method to a server communication method in a peer-to-peer communication system according to an embodiment.

FIG. 8 is a flowchart for illustrating a process of changing the data subscription method of a reception terminal from a server communication method to a direct communication method in a peer-to-peer communication system according to an embodiment.

FIG. 9 is an exemplary diagram for illustrating a process of changing the subscription path of a reception terminal from a direct communication method to a server communication method in response to a request from a transmission terminal in a peer-to-peer communication system according to an embodiment.

FIGS. 10 to 12 are exemplary diagrams for illustrating a process of changing part of the subscription path of a reception terminal from a direct communication method to a server communication method in response to a request from a transmission terminal in a peer-to-peer communication system according to an embodiment.

FIG. 13 is a block diagram of a computing environment including a computing apparatus suitable for being used in embodiments.

### DETAILED DESCRIPTION

Hereinafter, detailed embodiments of the disclosure are described with reference to the accompanying drawings. The following description is provided to help comprehensive understanding of a method, apparatus and/or system described in this specification. However, this is merely illustrative and the disclosure is not restricted by the following description.

In describing embodiments of the disclosure, a detailed description of a known technology related to the disclosure will be omitted if it is deemed to make the gist of the disclosure unnecessarily vague. Furthermore, terms to be described hereunder have been defined by taking into consideration functions in the disclosure, and may be different depending on a user, an operator's intention or practice. Accordingly, each term should be defined based on contents over the entire specification. Terms used in the detailed description are merely for describing embodiments of the disclosure and should not be limitative. An expression of the singular number includes a meaning of plural expressions, unless clearly expressed otherwise in the context. In the description, the terms, such as “include” or “have”, should be understood to indicate the existence of characteristics, numbers, steps, operations, elements or part or a combination of them, and should not to exclude the existence or possibility of one or more other characteristics, numbers, steps, operations, elements or part or a combination of them.

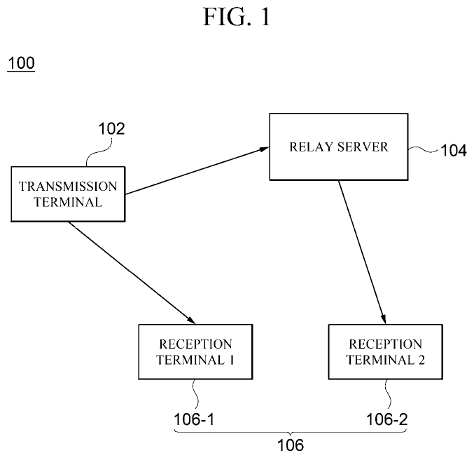

FIG. 1 is a block diagram of a peer-to-peer communication system 100 in a partial mesh network according to an embodiment. As illustrated in FIG. 1, the peer-to-peer communication system 100 according to an embodiment includes a transmission terminal 102, a relay server 104 and one or more reception terminals 106.

The transmission terminal 102 is a terminal for providing data to the reception terminals 106. The transmission terminal 102 may directly collect data and provide the data to the reception terminal 106 or may provide the reception terminal 106 with data received from another terminal (not illustrated). In the disclosed embodiment, the type and format of data transmitted from the transmission terminal 102 to the reception terminal 106 is not specially limited, and the data may include all of types of data which may be transmitted over a network without restriction.

The relay server 104 is a server apparatus for receiving data from the transmission terminal 102 and relaying the data to the reception terminal 106. In disclosed embodiments, the reception terminal 106 may directly receive data from the transmission terminal 102 (i.e., direct communication method), or may receive data via the relay server 104 (i.e., server communication method).

The reception terminal 106 is a terminal for receiving (or subscribing) data provided by the transmission terminal 102. The reception terminal 106 may determine whether to receive data using a direct communication method or whether to receive data using a server communication method from the transmission terminal 102. If the reception terminal 106 determines to receive data using the direct communication method, the reception terminal 106 may directly transmit a data subscription request to the transmission terminal 102. In contrast, if the reception terminal 106 determines to receive data using a server communication method, the reception terminal 106 may transmit a data subscription request to the relay server 104.

In one embodiment, the data subscription request includes subscription information of the reception terminal 106. The subscription information may include identification information of the reception terminal 106 (e.g., the network address of the reception terminal 106 or the ID of the reception terminal 106) and data information to be received by the reception terminal 106. The embodiment illustrated in FIG. 1 shows an example in which a reception terminal 1 (e.g., 106-1) of the two reception terminals 106 receives data from the transmission terminal 102 using the direct communication method and a reception terminal 2 (e.g., 106-2) receives data from the transmission terminal 102 using a server communication method. Although the number of reception terminals 106 has been illustrated as being 2 in FIG. 1, disclosed embodiments are not limited to the number of reception terminals 106.

The relay server 104 may store and manage a relay list in an internal storage space. The relay list is a list in which information regarding to which reception terminal 106 data received from the transmission terminal 102 will be relayed is stored. When a data subscription request is received from the reception terminal 106, the relay server 104 adds, to the relay list, subscription information of the reception terminal 106 included in the received subscription request, and forwards the received subscription request to the transmission terminal 102.

The transmission terminal 102 may store and manage a peer transmission list and a server transmission list in an internal storage space. The peer transmission list is a list in which the reception terminal 106 that wants to receive data using a direct communication method and data information to be received by the corresponding reception terminal 106 are stored. Furthermore, the server transmission list is a list in which the reception terminal 106 that wants to receive data using a server communication method and data information to be received by the corresponding reception terminal 106 are stored. When a data subscription request is received from the relay server 104, the transmission terminal 102 adds, to a server transmission list, subscription information of the reception terminal 106 included in the data subscription request. Furthermore, when a data subscription request is directly received from the reception terminal 106, the transmission terminal 102 adds, to a peer transmission list, subscription information of the reception terminal 106 that has transmitted the data subscription request.

If the reception terminal 106 wants to no longer receive data from the transmission terminal 102, the reception terminal 106 may transmit a data subscription cancellation request to the transmission terminal 102. If the reception terminal 106 is receiving data using a server communication method, the reception terminal 106 may transmit the data subscription cancellation request to the relay server 104. When the data subscription cancellation request is received from the reception terminal 106, the relay server 104 deletes subscription information of the reception terminal 106 from a relay list and forwards the received data subscription cancellation request to the transmission terminal 102. Thereafter, the transmission terminal 102 deletes the subscription information of the reception terminal 106 from a server transmission list in response to the data subscription cancellation request received from the relay server 104.

In contrast, if the reception terminal 106 is receiving data using a direct communication method, the reception terminal 106 may directly transmit a data subscription cancellation request to the transmission terminal 106. When the data subscription cancellation request is directly received from the reception terminal 106, the transmission terminal 102 deletes subscription information of the reception terminal 106 from a peer transmission list.

In one embodiment, the transmission terminal 102, the relay server 104 and the one or more reception terminals 106 may be implemented in a computing apparatus including one or more processors and a computer-readable recording medium connected to the processor. The computer-readable recording medium may be positioned inside or outside the processors or may be connected to the processors by well-known means. A processor within each computing apparatus may enable the computing apparatus to operate based on an exemplary embodiment described in this specification. For example, the processor may execute instructions stored in a computer-readable recording medium. The instructions stored in the computer-readable recording medium may be configured to enable the computing apparatus to perform operations according to an exemplary embodiment described in this specification when the instructions are executed by the processor.

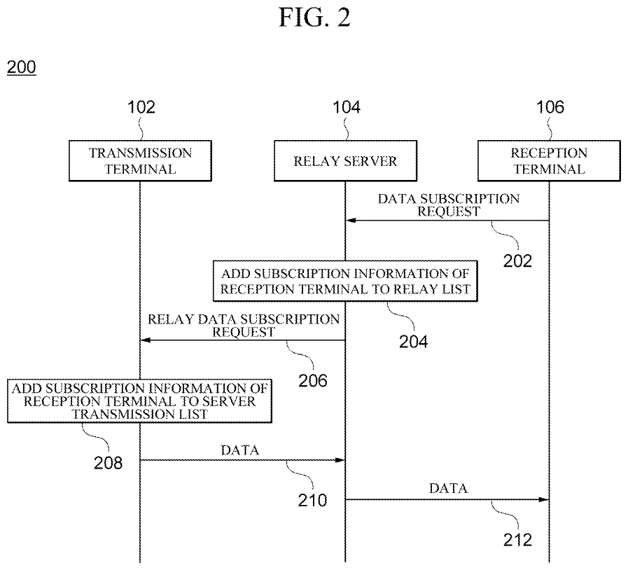

FIG. 2 is a flowchart for illustrating a process 200 of subscribing, by the reception terminal 106, data from the transmission terminal 102 using a server communication method in the peer-to-peer communication system 100 according to an embodiment. In the illustrated flowcharts, the method or process has been illustrated as being divided into a plurality of steps, but at least some of the steps may be changed in their order and performed, may be combined with other steps and performed, may be omitted, may be divided into sub-steps and performed, or one or more steps (not illustrated) may be added to at least some of the steps and performed.

At step 202, the reception terminal 106 transmits a data subscription request to the relay server 104 in order to receive data using a server communication method.

At step 204, when the data subscription request is received from the reception terminal 106, the relay server 104 adds, to a relay list, subscription information of the reception terminal 106 included in the received subscription request.

At step 206, the relay server 104 forwards the received subscription request to the transmission terminal 102.

At step 208, the transmission terminal 102 adds, to a server transmission list, the subscription information of the reception terminal 106 in response to the data subscription request received from the relay server 104.

At step 210, the transmission terminal 102 transmits, to the relay server 104, the data requested by the reception terminal 106.

At step 212, the relay server 104 forwards, to the reception terminal 106, the data received from the transmission terminal 102.

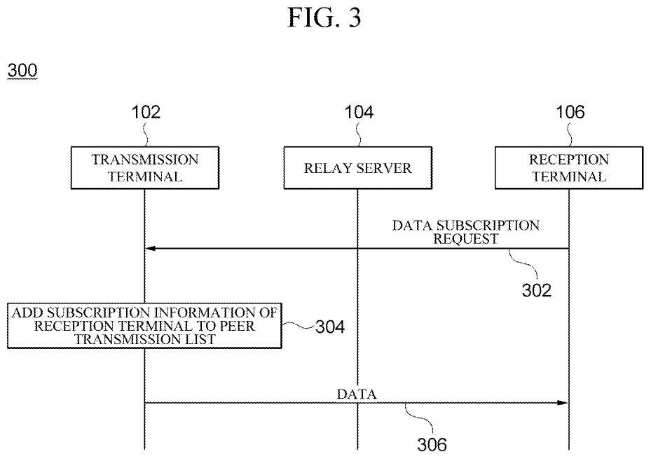

FIG. 3 is a flowchart for illustrating a process 300 of subscribing, by the reception terminal 106, data from the transmission terminal 102 using a direct communication method in the peer-to-peer communication system 100 according to an embodiment.

At step 302, the reception terminal 106 directly transmits a data subscription request to the transmission terminal 102 in order to receive data using a direct communication method.

At step 304, when the data subscription request is received from the reception terminal 106, the transmission terminal 102 adds, to a peer transmission list, subscription information of the reception terminal 106 included in the received subscription request.

At step 306, the transmission terminal 102 transmits the requested data to the reception terminal 106.

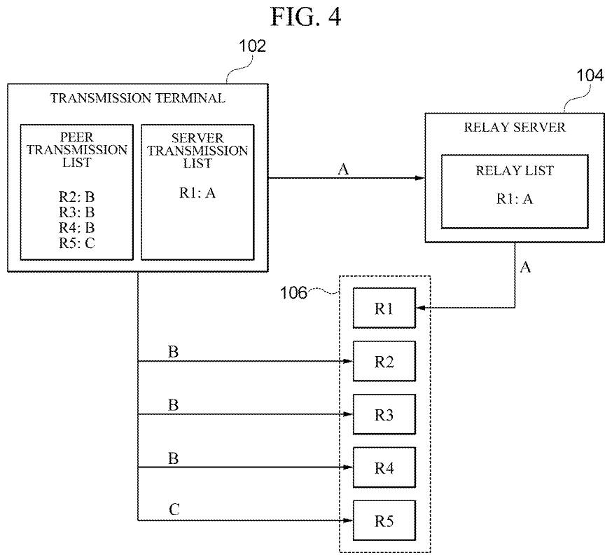

FIG. 4 is an exemplary diagram illustrating an example in which the transmission terminal 102 provides data to five reception terminals 106 (R1, R2, R3, R4 and R5). In the exemplary diagram illustrated in FIG. 4, subscription information registered with the peer transmission list of the transmission terminal 102 is as follows.

R2:B

R3:B

R4:B

R5:C

That is, according to the subscription information, it can be seen that each of the reception terminals R2, R3 and R4 has requested data B and the reception terminal R5 has requested data C using direct communication methods.

Subscription information registered with the server transmission list of the transmission terminal 102 is as follows.

R1:A

That is, according to the subscription information, it can be seen that the reception terminal R1 has requested data A using a server communication method.

Subscription information registered with the relay list of the relay server 104 is the same as that registered with the server transmission list of the transmission terminal 102.

In such a situation, each of the reception terminals R2, R3 and R4 receives the data B from the transmission terminal 102 using a direct communication method, and the reception terminal R5 receives the data C from the transmission terminal 102 using a direct communication method. Furthermore, the reception terminal R1 receives the data A via the relay server 104 from the transmission terminal 102 using a server communication method.

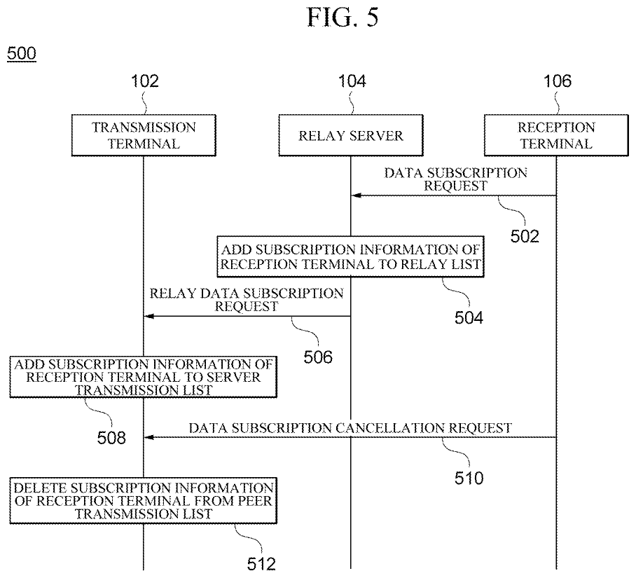

FIG. 5 is a flowchart for illustrating a process 500 of changing the data subscription method of the reception terminal 106 from a direct communication method to a server communication method in the peer-to-peer communication system 100 according to an embodiment. In this case, a change in the subscription method of the reception terminal 106 is performed in such a manner that the reception terminal 106 transmits a data subscription request to the relay server 104 and transmits a data subscription cancellation request to the transmission terminal 102.

At step 502, the reception terminal 106 that subscribes data using a direct communication method transmits a data subscription request to the relay server 104 in order to change a data subscription method into a server communication method.

At step 504, when the data subscription request is received from the reception terminal 106, the relay server 104 adds, to a relay list, subscription information of the reception terminal 106 included in the received subscription request.

At step 506, the relay server 104 forwards the received subscription request to the transmission terminal 102.

At step 508, the transmission terminal 102 adds, to a server transmission list, the subscription information of the reception terminal 106 in response to the data subscription request received from the relay server 104.

At step 510, the reception terminal 106 transmits a data subscription cancellation request to the transmission terminal 102. In one embodiment, step 510 may be performed simultaneously with step 502 or the order of step 510 and step 502 may be changed.

At step 512, when the data subscription cancellation request is received, the transmission terminal 102 deletes the subscription information of the reception terminal 106 from a peer transmission list.

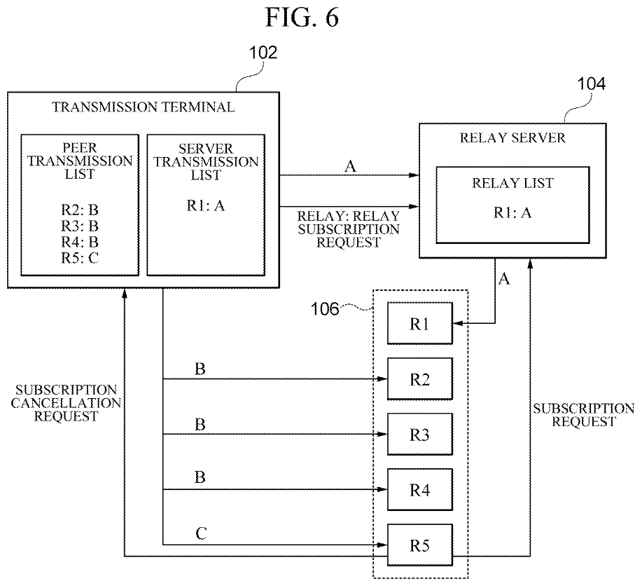

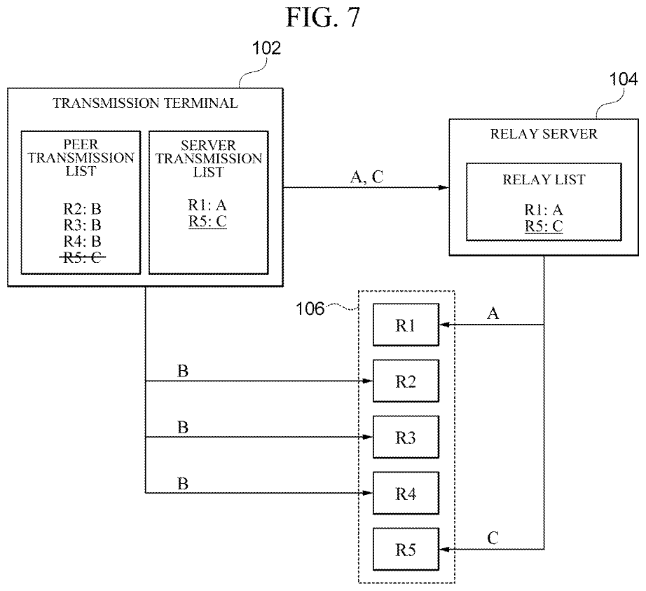

FIGS. 6 and 7 are exemplary diagrams for illustrating a process of changing the data subscription method of the reception terminal 106 from a direct communication method to a server communication method in the peer-to-peer communication system 100 according to an embodiment.

As illustrated in FIG. 6, it is assumed that each of reception terminals R2, R3 and R4 is receiving data B from the transmission terminal 102 using a direct communication method, a reception terminal R5 is receiving data C from the transmission terminal 102 using a direct communication method, and a reception terminal R1 is receiving data A from the transmission terminal 102 using a server communication method. If the reception terminal R5 wants to change the subscription method of the data C from the direct communication method to the server communication method, as in FIG. 5, the reception terminal R5 transmits a subscription request for the data C to the relay server 104 and transmits a subscription cancellation request for the data C to the transmission terminal 102.

Thereafter, as illustrated in FIG. 7, the relay server 104 that has received the subscription request adds subscription information (R5:C) of the reception terminal R5 to a relay list, and transmits the received subscription request to the transmission terminal 102. Accordingly, the reception terminal 102 adds the subscription information (R5:C) of the reception terminal R5 to a server transmission list, and separately deletes the subscription information of the reception terminal R5 from a peer transmission list in response to the subscription cancellation request received from the reception terminal R5.

When the process is completed, the reception terminal R5 receives the data C using the server communication method not the direct communication method.

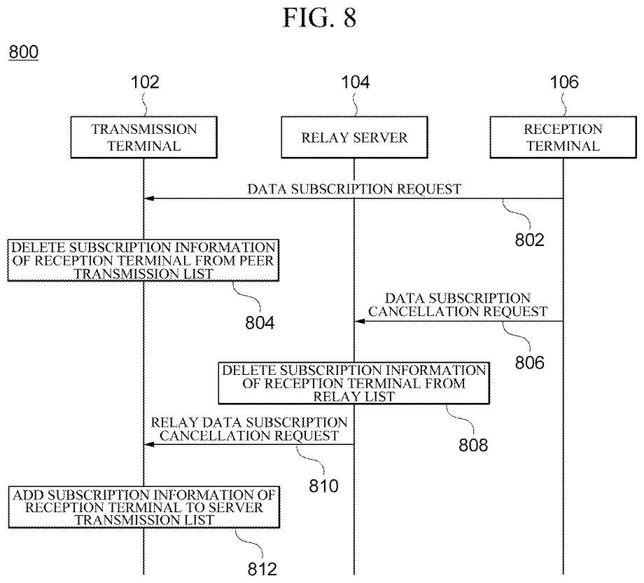

FIG. 8 is a flowchart for illustrating a process 800 of changing the data subscription method of the reception terminal 106 from a server communication method to a direct communication method in the peer-to-peer communication system 100 according to an embodiment. In this case, a change in the subscription method of the reception terminal 106 is performed in such a manner that the reception terminal 106 transmits a data subscription request to the transmission terminal 102 and transmits a data subscription cancellation request to the relay server 104.

At step 802, the reception terminal 106 that is receiving data using a server communication method transmits a data subscription request to the transmission terminal 102 in order to change a data subscription method into a direct communication method.

At step 804, when the data subscription request is received from the reception terminal 106, the transmission terminal 102 adds, to a peer transmission list, subscription information of the reception terminal 106 included in the received subscription request.

At step 806, the reception terminal 106 transmits a data subscription cancellation request to the relay server 104. In one embodiment, step 806 may be performed simultaneously with step 802, or the order of step 806 and step 802 may be changed.

At step 808, when the data subscription cancellation request is received, the relay server 104 deletes the subscription information of the transmission terminal 102 from a relay list.

At step 810, the relay server 104 forwards, to the transmission terminal 102, the subscription cancellation request received from the reception terminal 106.

At step 812, when the data subscription cancellation request is received, the transmission terminal 102 deletes the subscription information of the transmission terminal 102 from a server transmission list.

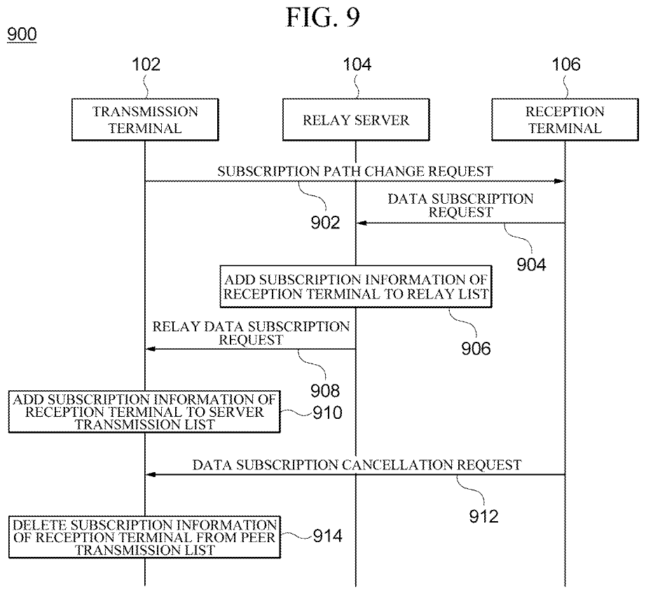

FIG. 9 is an exemplary diagram for illustrating a process 900 of changing the subscription path of the reception terminal 106 from a direct communication method to a server communication method in response to a request from the transmission terminal 102 in the peer-to-peer communication system 100 according to an embodiment.

In one embodiment, if the number or ratio of reception terminals 106 that have requested a subscription for the same data, among a plurality of reception terminals 106 included in a peer transmission list, is a reference value or more, the transmission terminal 102 may make a subscription path change request from a corresponding terminal. That is, if the transmission terminal 102 determines that a network bandwidth is inefficiently used because the same data is redundantly transmitted to the plurality of reception terminals 106, the transmission terminal 102 may transmit a subscription path change request to one or more of the reception terminals 106 that receive the same data using a direct communication method. The reception terminal 106 that has received the subscription path change request may change a subscription path from the direct communication method to a server communication method by transmitting a subscription request to the relay server 104 and transmitting a subscription cancellation request to the transmission terminal 102.

At step 902, the transmission terminal 102 transmit a subscription path change request to the reception terminal 106 that subscribes data using a direct communication method.

At step 904, the reception terminal 106 that has received the subscription path change request transmits a data subscription request to the relay server 104 in order to change a data subscription method into a server communication method.

At step 906, when the data subscription request is received from the reception terminal 106, the relay server 104 adds, to a relay list, subscription information of the reception terminal 106 included in the received subscription request.

At step 908, the relay server 104 forwards the received subscription request to the transmission terminal 102.

At step 910, the transmission terminal 102 adds, to a server transmission list, the subscription information of the reception terminal 106 in response to the data subscription request received from the relay server 104.

At step 912, the reception terminal 106 transmits a data subscription cancellation request to the transmission terminal 102. In one embodiment, step 912 may be performed simultaneously with step 904, or the order of step 912 and step 904 may be changed.

At step 914, when the data subscription cancellation request is received, the transmission terminal 102 deletes the subscription information of the transmission terminal 102 from a peer transmission list.

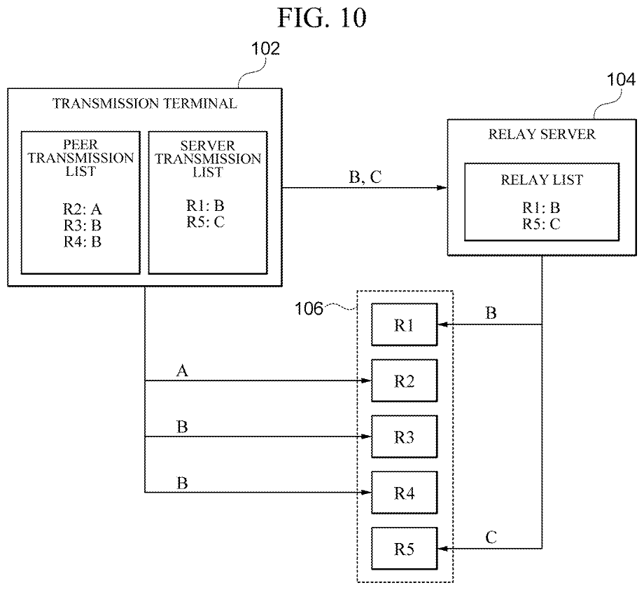

FIGS. 10 to 12 are exemplary diagrams for illustrating a process of changing part of the subscription path of the reception terminal 106 from a direct communication method to a server communication method in response to a request from the transmission terminal 102 in the peer-to-peer communication system 100 according to an embodiment.

As illustrated in FIG. 10, it is assumed that a reception terminal R2 is receiving data A from the transmission terminal 102 using a direct communication method, each of reception terminals R3 and R4 is receiving data B from the transmission terminal 102 using the direct communication method, a reception terminal R1 is receiving the data B from the transmission terminal 102 using a server communication method, and a reception terminal R5 is receiving data C from the transmission terminal 102 using the server communication method. In this case, the transmission terminal 102 has to redundantly transmit the same data B to the reception terminals R3 and R4 in order to transmit the same data B to the reception terminals R3 and R4.

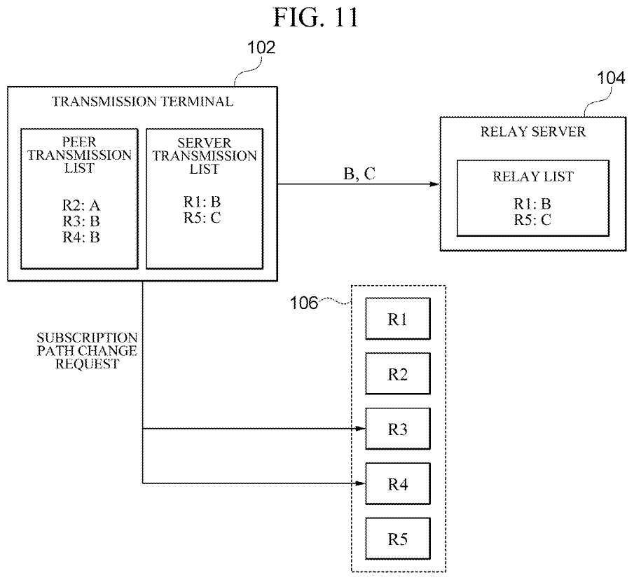

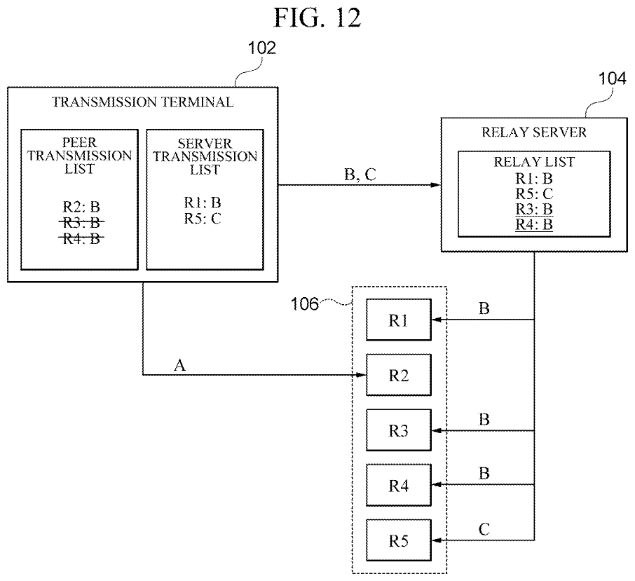

In such a situation, as illustrated in FIG. 11, the transmission terminal 102 may transmit a subscription path change request to the reception terminals R3 and R4. In response thereto, the reception terminals R3 and R4 changes the subscription method of the data B from the direct communication method to a server communication method. When a change in the communication method is completed, as illustrated in FIG. 12, the reception terminals R3 and R4 receive the data B via the relay server 104. The transmission terminal 102 has only to transmit the data B to the relay server 104 only once. Accordingly, network usage can be effectively reduced.

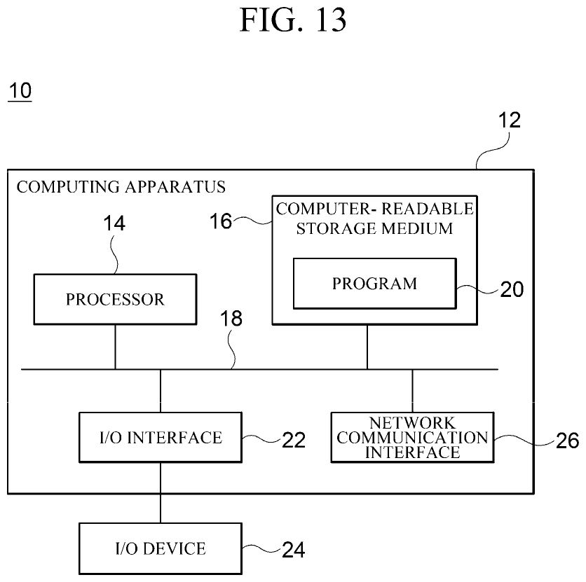

FIG. 13 is a block diagram of a computing environment 10 including a computing apparatus 12 suitable for being used in embodiments. In the illustrated embodiment, each of components included in the computing environment 10 may have a different function and capability in addition to those described below, and the computing environment may include an additional component in addition to the components described below.

The computing environment 10 includes the computing apparatus 12. In one embodiment, the computing apparatus 12 may be the transmission terminal 102, the relay server 104 and one or more reception terminals 106 according to the embodiments of the disclosure. The computing apparatus 12 includes at least one processor 14, a computer-readable storage medium 16 and a communication bus 18. The processor 14 may enable the computing apparatus 12 to operate according to the above-described embodiment. For example, the processor 14 may execute one or more programs stored in the computer-readable storage medium 16. The one or more programs may include one or more computer-executable instructions. The computer-executable instructions may be configured to enable the computing apparatus 12 to perform operations according to an exemplary embodiment when the computer-executable instructions are executed by the processor 14.

The computer-readable storage medium 16 is configured to store computer-executable instructions to a program code, program data and/or information having another suitable for. A program 20 stored in the computer-readable storage medium 16 includes a set of instructions executable by the processor 14. In one embodiment, the computer-readable storage medium 16 may be a memory (e.g., a volatile memory, such as a random access memory, a non-volatile memory or a proper combination of them), one or more magnetic disk storage devices, optical disk storage devices, flash memory devices, another form of storage media capable of storing data accessed and requested by the computing apparatus 12, or a proper combination of them.

The communication bus 18 interconnects other various components of the computing apparatus 12, including the processor 14 and the computer-readable storage medium 16.

Furthermore, the computing apparatus 12 may include one or more input/output (I/O) interfaces 22 for providing an interface for one or more I/O devices 24 and one or more network communication interfaces 26. The I/O interfaces 22 and the network communication interfaces 26 are connected to the communication bus 18. The I/O devices 24 may be connected to other components of the computing apparatus 12 through the I/O interfaces 22. The I/O devices 24 may include a pointing device (e.g., a mouse or a track pad), a keyboard, a touch input device (e.g., a touch pad or a touch screen), a voice or sound input device, input devices, such as various types of sensors and/or photographing devices, and/or output devices, such as a display, a printer, a speaker and/or a network card. The I/O device 24 may be included in the computing apparatus 12 as one component configuring the computing apparatus 12 or may be connected to the computing apparatus 12 as a device different from the computing apparatus 12.

According to the disclosed embodiments, the redundant transmission of data can be prevented and data can be efficiently transmitted because a data transmission path selected by a reception peer is synchronized with a transmission peer and a relay server when data is transmitted and received between the transmission peer and the reception peer in a partial mesh network.

The embodiment of the disclosure may include a program for executing the methods described in this specification on a computer and a computer-readable recording medium including the program. The computer-readable recording medium may include program instructions, a local data file or a local data structure solely or in combination. The medium may have been specially designed or configured for the disclosure or may be commonly available in the computer software field. Examples of the computer-readable recording medium include magnetic media such as a hard disk, a floppy disk and a magnetic disk, optical media such as a CD-ROM and a DVD, and hardware devices specially configured to store and execute program instructions, such as a ROM, a RAM, and a flash memory. Examples of the program may include machine-language code, such as code written by a compiler, and high-level language code executable by a computer using an interpreter.

Although the embodiments of the disclosure have been described in detail above, a person having ordinary skill in the art to which the disclosure pertains will understand that the embodiments may be modified in various ways without departing from the category of the disclosure. Accordingly, the range of right of the disclosure should not be limited to the above-described embodiments, but should be defined by the appended claims and equivalent thereof.

What is claimed is:

1. A peer-to-peer communication system, comprising:
a relay server configured to add, to a relay list, subscription information of a reception terminal included in a data subscription request in response to the data subscription request received from the reception terminal; and
a transmission terminal configured to receive the data subscription request from the relay server and add the subscription information of the reception terminal to a server transmission list.

2. The peer-to-peer communication system of claim 1, wherein the subscription information comprises identification information of the reception terminal and data information to be received by the reception terminal.

3. The peer-to-peer communication system of claim 1, wherein when a data subscription cancellation request is received from the reception terminal, the relay server is further configured to delete the subscription information of the reception terminal from the relay list.

4. The peer-to-peer communication system of claim 3, wherein the transmission terminal is further configured to receive the data subscription cancellation request from the relay server and delete the subscription information of the reception terminal from the server transmission list.

5. The peer-to-peer communication system of claim 1, wherein when the data subscription request is directly received from the reception terminal, the transmission terminal is further configured to add the subscription information of the reception terminal to a peer transmission list.

6. The peer-to-peer communication system of claim 5, wherein when a data subscription cancellation request is directly received from the reception terminal, the transmission terminal is further configured to delete the subscription information of the reception terminal from the peer transmission list.

7. The peer-to-peer communication system of claim 5, wherein if a number or ratio of terminals that have requested a subscription for identical data, among a plurality of reception terminals included in the peer transmission list, is a reference value or more, the transmission terminal is further configured to transmit a subscription path change request to a corresponding terminal.

8. The peer-to-peer communication system of claim 7, wherein a reception terminal that has received the subscription path change request is configured to transmit a subscription request to the relay server and transmit a subscription cancellation request to the transmission terminal.

9. A peer-to-peer communication method, comprising:
receiving, by a relay server, a data subscription request from a reception terminal;
adding, by the relay server, subscription information of the reception terminal included in the received data subscription request to a relay list; and
receiving, by a transmission terminal, the data subscription request from the relay server and adding the subscription information of the reception terminal to a server transmission list.

10. The peer-to-peer communication method of claim 9, wherein the subscription information comprises identification information of the reception terminal and data information to be received by the reception terminal.

11. The peer-to-peer communication method of claim 9, wherein when a data subscription cancellation request is received from the reception terminal, the relay server deletes the subscription information of the reception terminal from the relay list.

12. The peer-to-peer communication method of claim 11, wherein the transmission terminal receives the data subscription cancellation request from the relay server and deletes the subscription information of the reception terminal from the server transmission list.

13. The peer-to-peer communication method of claim 9, wherein when the data subscription request is directly received from the reception terminal, the transmission terminal adds the subscription information of the reception terminal to a peer transmission list.

14. The peer-to-peer communication method of claim 13, wherein when a data subscription cancellation request is directly received from the reception terminal, the transmission terminal deletes the subscription information of the reception terminal from the peer transmission list.

15. The peer-to-peer communication method of claim 13, wherein if a number or ratio of terminals that have requested a subscription for identical data, among a plurality of reception terminals included in the peer transmission list, is a reference value or more, the transmission terminal transmits a subscription path change request to a corresponding terminal.

16. The peer-to-peer communication method of claim 15, wherein a reception terminal that has received the subscription path change request transmits a subscription request to the relay server and transmits a subscription cancellation request to the transmission terminal.
